(19) United States
(12) Patent Application Publication
(10) Pub. No.: US 2004/0037531 A1
(43) Pub. Date: Feb. 26, 2004

(54) Waveguide device with a tailored thermal response

(76) Inventors: Mark P. Andrews, Westmount (CA); Shao-Wei Fu, St-Laurent (CA); Maria Petrucci-Samija, St-Sauveur (CA)

Correspondence Address: KNOBBE MARTENS OLSON & BEAR LLP, 2040 MAIN STREET, FOURTEENTH FLOOR, IRVINE, CA, 92614, US

(21) Appl. No.: 10/225,478

(22) Filed: Aug. 20, 2002

(51) Int. Cl. G02B 6/10

(52) U.S. Cl. 385/130

(57) ABSTRACT

A waveguide device having a tailored thermal response includes a solvent-resistant substrate including a surface, the substrate having a thermal coefficient of expansion. The waveguide device further includes a waveguide layer formed on the surface of the substrate. The waveguide layer has a temperature-dependent refractive index characterized by a negative thermo-optical coefficient. The thermal response of the waveguide device includes a temperature-dependent wavelength shift proportional to a thermal response parameter equal to a sum of the thermo-optical coefficient and the product of the refractive index and the thermal coefficient of expansion.

### BACKGROUND OF THE INVENTION

1. Field of the Invention

This invention relates to the temperature-dependent optical performance of optical waveguide devices, including wavelength-division multiplexers/demultiplexers.

2. Description of the Related Art

Wavelength-division multiplexers/demultiplexers (WDMs), such as arrayed waveguide gratings (AWGs), are used to increase the available bandwidth of a fiber-optical network system by transmitting multiple optical signals concurrently over the fiber. Each optical signal is assigned a specific wavelength within a designated band of wavelengths, and the optical signals are multiplexed together to be transmitted along the fiber. Upon reaching the fiber output, the signals are demultiplexed into the separate signals, which are coupled into separate waveguides or channels.

However, conventional silica-based WDMs have a non-negligible thermal response, which alters the optical performance of the WDMs as a function of temperature. For example, variations in temperature can generate wavelength shifts of the central wavelength at the output ports of the WDM, or otherwise alter the bandpass characteristics of the WDM. These temperature-dependent wavelength shifts can degrade the performance and stability of WDMs in optical network systems. In an effort to avoid this temperature-dependent wavelength shift, prior art systems have required heating and cooling subsystems designed to maintain a constant operating temperature for the WDM. These temperature compensation subsystems adversely impact the complexity, size, expense, and utility of such optical network systems.

### SUMMARY OF THE INVENTION

According to one aspect of the present invention, a waveguide device has a tailored thermal response. The waveguide device comprises a solvent-resistant substrate comprising a surface, the substrate having a thermal coefficient of expansion and comprising chlorotrifluoroethylene (CTFE) polymer. The waveguide device further comprises a waveguide layer formed on the surface of the substrate. The waveguide layer has a temperature-dependent refractive index characterized by a negative thermo-optical coefficient. The thermal response of the waveguide device comprises a temperature-dependent wavelength shift proportional to a thermal response parameter equal to a sum of the thermo-optical coefficient and the product of the refractive index and the thermal coefficient of expansion.

In another aspect of the present invention, a waveguide device has a tailored thermal response. The waveguide device comprises a solvent-resistant substrate comprising a surface, the substrate having a thermal coefficient of expansion and comprising polyetherimide. The waveguide device further comprises a waveguide layer formed on the surface of the substrate. The waveguide layer has a temperature-dependent refractive index characterized by a negative thermo-optical coefficient. The thermal response of the waveguide device comprises a temperature-dependent wavelength shift proportional to a thermal response parameter equal to a sum of the thermo-optical coefficient and the product of the refractive index and the thermal coefficient of expansion.

In another aspect of the present invention, a waveguide device has a tailored thermal response. The waveguide device comprises a solvent-resistant substrate comprising a surface, the substrate having a thermal coefficient of expansion and comprising a material selected from the group consisting of polyethylfluoroethylene, glass-filled poly(imide), glass-filled black polycarbonate, and fluoro-ethylene-propylene polymer. The waveguide device further comprises a waveguide layer formed on the surface of the substrate. The waveguide layer has a temperature-dependent refractive index characterized by a negative thermo-optical coefficient. The thermal response of the waveguide device comprises a temperature-dependent wavelength shift proportional to a thermal response parameter equal to a sum of the thermo-optical coefficient and the product of the refractive index and the thermal coefficient of expansion.

In another aspect of the present invention, a waveguide device has a tailored thermal response. The waveguide device comprises a solvent-resistant substrate comprising a surface, the substrate having a thermal coefficient of expansion and comprising a material selected from the group consisting of chlorotrifluoroethylene (CTFE) polymer, polyetherimide, polyethylfluoroethylene, glass-filled poly(imide), glass-filled black polycarbonate, and fluoro-ethylene-propylene polymer. The waveguide device further comprises a waveguide layer formed on the surface of the substrate. The waveguide layer has a temperature-dependent refractive index characterized by a negative thermo-optical coefficient. The thermal response of the waveguide device comprises a temperature-dependent wavelength shift proportional to a thermal response parameter equal to a sum of the thermo-optical coefficient and the product of the refractive index and the thermal coefficient of expansion.

In another aspect of the present invention, a method for fabricating a waveguide device having a tailored thermal response uses wet etch processing. The method comprises providing a solvent-resistant substrate having a surface, the substrate having a thermal coefficient of expansion and comprising chlorotrifluoroethylene (CTFE) polymer. The method further comprises forming a buffer layer on the surface of the substrate. The method further comprises forming a guide layer on the buffer layer, wherein forming the guide layer comprises patterning the guide layer by exposing the guide layer, buffer layer, and substrate to a solvent. The guide layer has a temperature-dependent refractive index characterized by a negative thermo-optical coefficient. The method further comprises forming a cladding layer on the patterned guide layer and the buffer layer. The method further comprises tailoring the thermal response of the waveguide device, the thermal response dependent on the thermal coefficient of expansion, on the temperature-dependent refractive index, and on the thermo-optical coefficient.

In another aspect of the present invention, a method for fabricating a waveguide device having a tailored thermal response uses wet etch processing. The method comprises providing a solvent-resistant substrate having a surface, the substrate having a thermal coefficient of expansion and comprising polyetherimide. The method further comprises forming a buffer layer on the surface of the substrate. The method further comprises forming a guide layer on the buffer layer, wherein forming the guide layer comprises patterning the guide layer by exposing the guide layer, buffer layer, and substrate to a solvent. The guide layer has a temperature-dependent refractive index characterized by a negative thermo-optical coefficient. The method further comprises forming a cladding layer on the patterned guide layer and the buffer layer. The method further comprises tailoring the thermal response of the waveguide device, the thermal response dependent on the thermal coefficient of expansion, on the temperature-dependent refractive index, and on the thermo-optical coefficient.

In another aspect of the present invention, a method for fabricating a waveguide device having a tailored thermal response uses wet etch processing. The method comprises providing a solvent-resistant substrate having a surface, the substrate having a thermal coefficient of expansion and comprising a material selected from the group consisting of glass-filled polyethylfluoroethylene, glass-filled poly(imide), glass-filled black polycarbonate, and fluoro-ethylene-propylene polymer. The method further comprises forming a buffer layer on the surface of the substrate. The method further comprises forming a guide layer on the buffer layer, wherein forming the guide layer comprises patterning the guide layer by exposing the guide layer, buffer layer, and substrate to a solvent. The guide layer has a temperature-dependent refractive index characterized by a negative thermo-optical coefficient. The method further comprises forming a cladding layer on the patterned guide layer and the buffer layer. The method further comprises tailoring the thermal response of the waveguide device, the thermal response dependent on the thermal coefficient of expansion, on the temperature-dependent refractive index, and on the thermo-optical coefficient.

In another aspect of the present invention, a method for fabricating a waveguide device having a tailored thermal response uses wet etch processing. The method comprises providing a solvent-resistant substrate having a surface, the substrate having a thermal coefficient of expansion and comprising a material selected from the group consisting of polycarbonates, polycyanurates, polyolefins, condensation polymers, polyacrylates, polysiloxanes, polyimides, ceramics, and doped glasses. The method further comprises forming a buffer layer on the surface of the substrate. The method further comprises forming a guide layer on the buffer layer, wherein forming the guide layer comprises patterning the guide layer by exposing the guide layer, buffer layer, and substrate to a solvent. The guide layer has a temperature-dependent refractive index characterized by a negative thermo-optical coefficient. The method further comprises forming a cladding layer on the patterned guide layer and the buffer layer. The method further comprises tailoring the thermal response of the waveguide device, the thermal response dependent on the thermal coefficient of expansion, on the temperature-dependent refractive index, and on the thermo-optical coefficient.

In another aspect of the present invention, a temperature-compensated optical system comprises a first optical device having a first thermal response. The optical system further comprises a second optical device optically coupled to the first optical device. The second optical device has a second thermal response which compensates for the first thermal response. The second optical device comprises a solvent-resistant substrate comprising a surface, the substrate having a thermal coefficient of expansion. The second optical device further comprises a waveguide layer formed on the surface of the substrate. The waveguide layer has a temperature-dependent refractive index characterized by a negative thermo-optical coefficient. The second thermal response comprises a temperature-dependent wavelength shift proportional to a thermal response parameter equal to a sum of the thermo-optical coefficient and the product of the refractive index and the thermal coefficient of expansion.

### BRIEF DESCRIPTION OF THE DRAWINGS

FIG. 1 schematically illustrates a waveguide device in accordance with an embodiment of the present invention.

FIG. 2 schematically illustrates a waveguide device with a substrate comprising a first portion and a second portion in accordance with embodiments of the present invention.

FIG. 3 schematically illustrates a waveguide device with a waveguide layer comprising a buffer layer, a guide layer, and a cladding layer in accordance with embodiments of the present invention.

FIGS. 4A and 4B are graphical comparisons of the measured temperature-dependent wavelength shift for a polymeric WDM on a silicon substrate and a polymeric WDM on a polymeric substrate comprising CTFE polymer.

FIG. 5 schematically illustrates a data acquisition system used to compile the data of FIGS. 4A and 4B.

FIGS. 6A and 6B are graphical comparisons of simulated output power for four output channels for a polymeric CWDM on the silicon substrate and a polymeric CWDM on a polymeric substrate comprising CTFE polymer.

FIG. 7 is a flowchart of an exemplary embodiment for fabricating a waveguide device using wet etch processing in accordance with embodiments of the present invention.

FIG. 8 schematically illustrates a temperature-compensated optical system in accordance with embodiments of the present invention.

### DETAILED DESCRIPTION OF THE PREFERRED EMBODIMENT

Prior art systems have sought to reduce or eliminate the temperature-dependent optical performance of silica-on-silicon optical devices by a variety of methods. These methods have included using an input coupling geometry which compensates for the thermal drifts of the device components, temperature-compensating waveguide regions or geometries, judicious combinations of materials with complementary thermal responses, or other means for compensating for temperature-dependent optical response. However, these methods generally require complicated fabrication techniques or the resultant devices exhibit additional insertion losses.

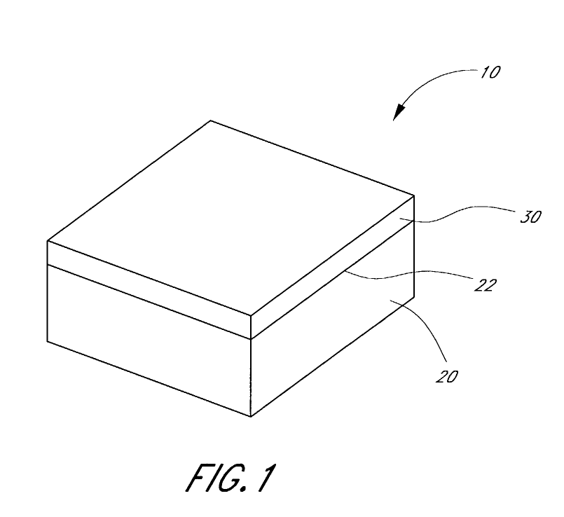

FIG. 1 schematically illustrates a waveguide device 10 having a tailored thermal response in accordance with embodiments of the present invention. The waveguide device 10 comprises a solvent-resistant substrate 20 comprising a surface 22, the substrate 20 having a thermal coefficient of expansion α_{sub}. The waveguide device 10 further comprises a waveguide layer 30 formed on the surface 22 of the substrate 20. The waveguide layer 30 has a temperature-dependent refractive index n_{g} characterized by a negative thermo-optical coefficient dn_{g}/dT. The thermal response of the waveguide device 10 comprises a temperature-dependent wavelength shift dλ/dT proportional to a thermal response parameter R(T) equal to a sum of the thermo-optical coefficient dn_{g}/dT and the product of the refractive index n_{g} and the thermal coefficient of expansion α_{sub}.

In certain embodiments, the waveguide device 10 comprises an arrayed-waveguide grating (AWG) or a wavelength-division multiplexer/demultiplexer (WDM), such as a dense wavelength-division multiplexer/demultiplexer (DWDM) or a coarse wavelength-division multiplexer/demultiplexer (CWDM). Such waveguide devices 10 are particularly sensitive to thermally-induced changes of the refractive index which can cause the central wavelength of these devices to shift in response to temperature fluctuations.

Examples of other waveguide devices 10 compatible with embodiments of the present invention include, but are not limited to, optical filters, Bragg gratings, ring resonators, multimode interference splitters, 1×n and m×n splitters, directional taps, and interferometers including Mach-Zehnder interferometers. Certain filters compatible with embodiments of the present invention are improved over prior art filters by keeping the wavelengths selected by the filter from shifting from a desired wavelength. Certain couplers, splitters, and interferometers compatible with embodiments of the present invention are improved over prior art devices by reducing the thermally-induced changes of the refractive indices, thereby improving device performance.

Rather than exhibiting completely athermal behavior, certain waveguide devices 10 compatible with embodiments of the present invention are improved over prior art devices by having a thermal behavior that can be tailored so as to track the thermal behavior of another optical device. For example, the thermal behavior of a waveguide device 10 can be tailored in accordance with embodiments of the present invention to track the temperature-induced wavelength shifting of a laser (e.g., a distributed feedback laser) that is not temperature-compensated.

In certain embodiments, the solvent-resistant substrate 20 comprises a material which is resistant to degradation from exposure to one or more solvents used in subsequent fabrication procedures. Examples of solvents to which various embodiments of the substrate 20 are resistant include, but are not limited to, acetone, inorganic corrosive liquids such as oxidizing acids, organic solvents excluding aromatic materials such as toluenes, mild alcohols, mild acids, mild alkalis, esters, ethers, and ketones. As explained more fully below, the solvent-resistant material is selected in part so as to provide a substrate 20 that does not degrade upon exposure to solvents and other chemicals of subsequent wet etch fabrication procedures.

For numerous reasons, wet etch procedures are particularly desirable for the fabrication of waveguide devices 10 over dry etch procedures such as reactive-ion etching (RIE). Certain wet etch processes can provide higher selectivity than dry etch processes. High selectivity can be achieved when the chemical reactions of the solvent with one material are thermodynamically favored over chemical reactions with another material. Such highly selective etching processes can result in essentially damage-free interfaces. Wet etch procedures can also provide isotropic etching, while dry etch procedures are typically anisotropic. In addition, since wafers can be wet-etched in batches and with fewer steps than dry etch procedures, wet etch processes can provide rapid processing, high-throughput, and more controllability. Wet etch processes also typically utilize less expensive equipment than do dry etch processes. These advantages of wet etch processes over dry etch processes can translate to manufacturability gains such as higher yields, lower production costs, and rapid time-to-market.

However, wet etch processes have the additional constraint of requiring a specific crosslinkable photo-pattemable function group in the polymer backbone. The presence of the crosslinkable photo-patternable function group is not required in dry etching processes. In addition, most polymerizable materials formed using a wet etch process can not withstand the strong bases or acids used in dry etching processes to remove the metal mask layer.

In certain athermal embodiments, the solvent-resistant substrate 20 entirely comprises a solvent-resistant material with a thermal coefficient of expansion α_{sub} between approximately 40×10⁻⁶/° C. and approximately 100×10⁻⁶/° C. In other embodiments in which the thermal response of the waveguide device is tailored to suit specific needs (e.g., to provide a positive wavelength shift to follow the wavelength shift of other optical devices), the thermal coefficient of expansion can be greater than approximately 100×10⁻⁶/° C. As explained more fully below, the solvent-resistant material is selected in part so as to have a thermal coefficient of expansion α_{sub} which, when combined with the thermo-optical coefficient dn_{g}/dT of the waveguide layer 30, provides a waveguide device 10 with a tailored thermal response.

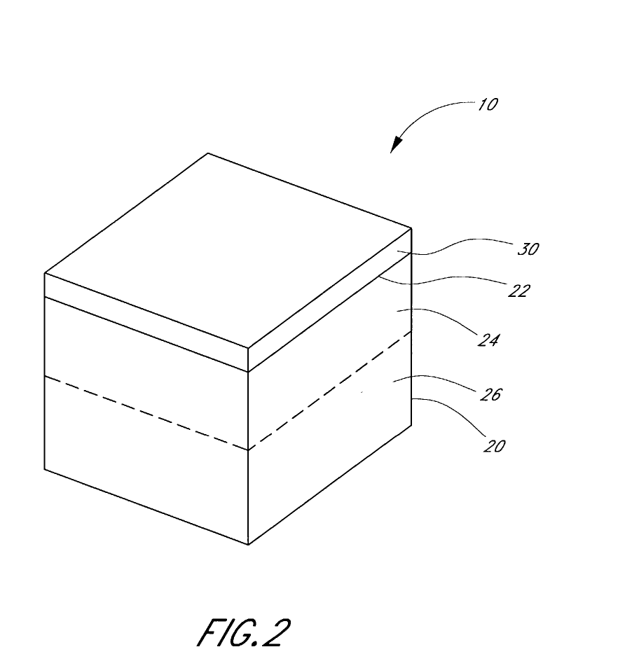

In certain other embodiments, as schematically illustrated in FIG. 2, the waveguide device 10 comprises a substrate 20 comprising a first portion 24 and a second portion 26. The first portion 24 of the substrate 20 comprises the surface 22 and has a thermal coefficient of expansion α_{sub} within the desired range, while the second portion 26 of the substrate 20 has a different thermal coefficient of expansion. The thickness of the portion 24 comprising the surface 22 in such embodiments is sufficiently large so that the thermal expansion of the waveguide layer 30 is characterized by the thermal coefficient of expansion α_{sub} of the first portion 24 rather than that of the second portion 26. In certain embodiments, this condition is satisfied by a thickness of the first portion 24 which is larger than approximately 500 microns.

Examples of solvent-resistant materials compatible with substrates 20 in accordance with embodiments of the present invention include, but are not limited to, chlorotrifluoroethylene (CTFE) polymer, polyetherimide or polyethylenimine (PEI), glass-filled polyethylfluoroethylene (PTFE), glass-filled poly(imide), glass-filled black polycarbonate, and fluoro-ethylene-propylene (FEP) polymer. PEI is available from GE Plastics (Ultem-1000, www.gepolymerland.com). Glass-filled poly(imide) is available as “Arlon 35N” from Arlon, Inc. of Santa Ana, Calif. or Amitec, Inc. of Migdal Haemek, Israel. CTFE polymer, glass-filled PTFE, glass-filled black polycarbonate, polycarbonate, and FEP polymer are available from McMaster-Carr Supply Company of Atlanta, Ga. Table 1 lists these materials, along with relevant characteristics which make these materials particularly compatible with embodiments of the present invention.

TABLE 1

| Substrate Material | αₑₓₚ | Relevant Characteristics |
|---|---|---|
| CTFE polymer | 63 × 10⁻⁶/° C. | Resistant to inorganic corrosive liquids including oxidizing |
| | | acids (but not to halogenated hydrocarbons or aromatic |
| | | solvents), mild acids, mild alkalis, and alcohols; Near-zero |
| | | moisture absorption; Can be machined, molded, welded, |
| | | thermoformed. |
| PEI | 54 × 10⁻⁶/° C. | Resistant to acidic solutions, hydrolysis, heat (continuously |
| | | to 170° C.); capable of withstanding repeated autoclaving |
| | | cycles. |
| Glass-Filled PTFE | 126 × 10⁻⁶/° C. | Resistant to acids and caustics from −212° C. to +260° C. (but |
| (25% glass) | | not to molten alkali metals or gaseous fluorine); Can be |
| | | machined. |
| Glass-Filled Black | 26.8 × 10⁻⁶/° C. | Resistant to alcohols, organic acids, and halogenated |
| Polycarbonate | | hydrocarbons (but not to petroleum, inorganic acids, and |
| (20% glass) | | aromatic hydrocarbons); Can be machined, molded, welded, |
| | | thermoformed. |
| Polycarbonate | 67.5 × 10⁻⁶/° C. | Resistant to acids, neutral and acid salts, and aliphatic and |
| | | cyclic hydrocarbons (but not to methylene chloride, ethylene |
| | | dichloride, and dioxane); Can be machined, molded, welded, |
| | | thermoformed. |
| FEP | 135 × 10⁻⁶/° C. | Resistant to most chemicals (but not to molten alkali metals, |
| | | fluorine, and fluorochemicals); Can be machined, molded, |
| | | welded, thermoformed; Low water absorption. |
| Glass-filled poly(imide) | 16-17 × 10⁻⁶/° C. | T_{g} greater than 250° C.; low Z direction expansion; Can be |
| (28% glass) | | machined; Low water absorption. |

In addition to having favorable thermal coefficients of expansion and resistance to solvents, the above-listed materials also satisfy various other processing constraints corresponding to wet etch processing, including but not limited to, thermal resistance to processing temperatures, adhesion to the waveguide layer 30 to maintain resilient waveguide devices 10, and rigidity to physically support the waveguide device 10. Adhesion and rigidity are particularly important for waveguide devices 10 fabricated using wet etch processes, because the combined effects of solvent exposure and elevated temperatures (used to facilitate removal of the solvents) can adversely deform the device 10. These deformations can include curling of the substrate 20 and delamination of the waveguide layer 30 from the substrate 20. Dry etch processes which utilize acids, such as HF or HCl/HNO₃ mixtures in aqueous solutions with no applied heat, are not as vulnerable to such deformations. In certain embodiments, the rigidity of the substrate 20 can be characterized as having a tensile strength greater than approximately 5000 psi, and an impact strength greater than approximately 1.5 ft-lbs/in.

The materials listed in Table 1 are either polymeric or are polymer blends with other materials. In embodiments in which a polymer/glass blend is utilized for the substrate 20, the thermal coefficient of expansion α_{sub} of the surface 22 can be tailored to a predetermined value by judicious formulation of the polymer to glass ratio. For example, Table 2 lists the coefficients of thermal expansion for blends of black polycarbonate with various percentages of glass.

TABLE 2

| Black Polycarbonate, % glass | αₑₓₚ (× 10⁻⁶/° C.) |
|---|---|
| 0% | 70.2 |
| 10% | 32.4 |
| 20% | 27.0 |
| 30% | 21.8 |
| 40% | 16.2 |

Other polymeric materials compatible with embodiments of the present invention include, but are not limited to, polycarbonates, polycyanurates, polyolefins (e.g., polypropylene), condensation polymers, polyacrylates, polysiloxanes, and polyimides. These materials have some or all of the desired attributes (e.g., favorable coefficients of thermal expansion, solvent resistance, high temperature resistance, good adhesive properties, and rigidity) of various embodiments of the present invention. Table 3 lists relevant information for some of these materials.

TABLE 3

| | αₑₓₚ | |
|---|---|---|
| Material | (× 10⁻⁶/° C.) | Other Properties |
| Polypropylene | 57.6 to 103 | Tensile strength = 5000 psi; |
| (not glass- | | Impact strength = 0.5-2.2 ft-lbs/in.; |
| filled) | | Deflection temperature at 66 psi = |
| | | 200-250° F. |
| Polypropylene | 28.8-52.2 | Tensile strength = 6000-14500 psi; |
| (glass-filled) | | Impact strength = 1.0-5.0 ft-lbs/in.; |
| | | Deflection temperature at 66 psi = 310° F. |
| Polyacrylates | 80 (typical) | Tensile strength = over 5000 psi (typical) |
| (crosslinked) | | |
| Polysiloxane | approx. 15 | Coefficient of thermal expansion |
| | | is tuneable by adding polymer. |
| Polyimide | 19.8-55.8 | Tensile strength = 15000-33500 psi; |
| | (typical) | Maximum temperature range = |
| | | 230=400° C. |

In addition, other non-polymeric materials which are compatible with embodiments of the present invention include, but are not limited to, ceramics and doped glasses. These materials can be doped with organic or inorganic materials.

Certain other substrate materials are incompatible with embodiments of the present invention. For example, Kokubun et al., in “Temperature-Independent Narrow-Band Optical Filter by an Athermal Waveguide,” IEICE Trans. Electron., Vol. E80-C, No. 5, May 1997, pages 632-638, describe a ring resonator utilizing a poly-methyl-methacrylate (PMMA) upper cladding strip layer. This PMMA layer was formed by reactive ion etching on a NA45 glass core layer and a SiO₂ lower cladding layer on a Si substrate. A PMMA substrate would be incompatible with wet etch processes utilizing ketones or acetates.

In addition, certain substrate materials compatible with embodiments of the present invention are incompatible with dry etch processes. For example, isocyanurates are etched away by HF vapor as used in certain RIE dry etch processes.

In an exemplary embodiment, the solvent-resistant substrate 20 comprises CTFE polymer. The thermal coefficient of expansion of CTFE polymer is approximately 63×10⁻⁶/° C. Besides its favorable thermal coefficient of expansion, the physical characteristics of CTFE polymer make it particularly compatible for use with embodiments of the present invention. CTFE polymer is chemically resistant to various chemicals which are used in the fabrication of planar optical waveguide devices, including but not limited to, inorganic corrosive liquids, including oxidizing acids, and solvents used in wet etching processes. CTFE polymer is also stable in the temperature ranges of the various optical device fabrication processes, typically up to approximately 200° C. CTFE polymer can be machined, molded, welded, and thermoformed to produce substrates 20 in a variety of configurations compatible with embodiments of the present invention. CTFE polymer also exhibits good adhesion to other materials used in the optical devices, including glue used to connect the optical device 10 to pigtails. In addition, CTFE polymer is commercially available from numerous suppliers.

In certain embodiments, the waveguide layer 30 comprises a material with a temperature-dependent refractive index n_{g}(T) characterized by a negative thermo-optical coefficient dn_{g}/dT. A negative thermo-optical coefficient dn_{g}/dT corresponds to a refractive index n_{g} of the waveguide layer 30 which decreases with increasing temperature. Certain waveguide layers 30 compatible with embodiments of the present invention have negative thermo-optical coefficients which range between approximately −6×10⁻⁵/° C. and approximately −15×10⁻⁵/° C.

Examples of polymeric materials for waveguide layers 30 compatible with embodiments of the present invention include, but are not limited to, ferroelectric polymers, polymer composites including polymers with liquid crystal droplets and polymers doped with metal particles, semiconducting particles, semiconductor quantum dots, or non-linear chromophores having second order (χ²) or third order (χ³) susceptibilities. In other embodiments, the waveguide layer 30 can comprise other materials including, but not limited to, glasses, hybrid organic-inorganic materials, and sol-gels. The refractive indices of these materials can range from approximately 1.3 to approximately 1.6, and the coefficients of thermal expansion can range from approximately −6×10⁻⁵/° C. to approximately −15×10⁻⁵/° C. In certain embodiments, the polymeric material for waveguide layers 30 can not survive exposure to the strong acids or bases which are used in dry etching processes, but these materials are compatible with wet etching processes. For example, polyisocyanurate can be wet-etched, but it will not resist HF which is used in some dry etching processes.

Certain waveguide layers 30 compatible with embodiments of the present invention are able to transmit or conduct light in a desired band of wavelengths, which can be from the visible to the near-infrared. In addition, certain waveguide layers 30 are able to provide non-linear effects in response to an incoming signal, such as generating an upconverted, frequency-doubled signal, providing magnetic properties which rotate the polarization of the incoming light signal, or providing electroactive properties used to switch light signals.

Waveguide layers 30 can be fabricated in accordance with embodiments of the present invention using various processing techniques including, but not limited to, spin coating, spray coating, extrusion coating, lithography, and wet etching. The processing techniques used to fabricate the waveguide layer 30 should provide the desired functionality (e.g., whether the layer is crosslinked or not). In addition, the processing techniques used to fabricate the waveguide layer 30 should be compatible with the underlying substrate 20 and other previously-fabricated portions of the waveguide device 10. For example, the substrate 20 should be compatible with the solvents and upper temperature limits used for processing the waveguide layer 30.

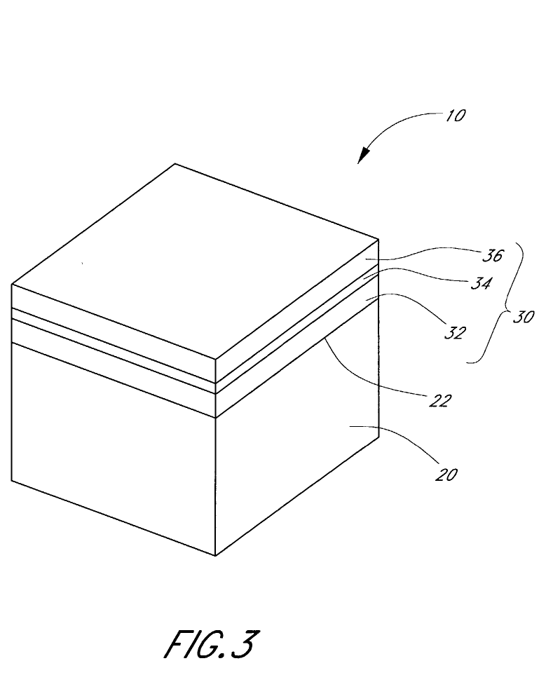

In certain embodiments, the waveguide layer 30 comprises multiple layers. As schematically illustrated in FIG. 3, the waveguide layer 30 of certain such embodiments comprises a buffer layer 32, a guide layer 34, and a cladding layer 36. The buffer layer 32 is formed on the surface 22 of the substrate 20 and provides an interface region between the substrate 20 and the guide layer 34. The guide layer 34 is formed on the buffer layer 32 and provides a conduit for optical signals. The cladding layer 36 is formed on the guide layer 34 and the buffer layer 32 and provides protection of the underlying layers. In addition, the refractive indices of the buffer layer 32, guide layer 34, and cladding layer 36 are selected to provide localization of the optical signals primarily within the guide layer 34. The thermal response of the resultant waveguide device 10 is dependent on the thermal coefficient of expansion of the substrate 20, and on the refractive index and thermo-optical coefficient of the guide layer 34.

The temperature-dependent wavelength shift dλ/dT of the central wavelength λ of certain embodiments of the waveguide device 10 is dependent on thermal properties such as the thermo-optical coefficient dn_{g}/dT of the waveguide layer 30 and the coefficient of thermal expansion α_{sub} of the surface 22 of the substrate 20. In such embodiments, the wavelength shift can be expressed as:

dλ/dT=(λ/n_{g})·R(T)=(λ/n_{g})·(dn_{g}/dT+n_{g}·α_{sub}),

where R(T) is a thermal response parameter of the waveguide device 10.

Lower values of the thermal response parameter R(T) correspond to smaller temperature-dependent wavelength shifts dλ/dT. In athermal embodiments (i.e., in embodiments in which the temperature-dependent wavelength shift dλ/dT is small), the values of the thermo-optical coefficient dn_{g}/dT, refractive index n_{g} of the waveguide layer 30, and the thermal coefficient of expansion α_{sub} of the substrate 20 are tailored so that the thermal response parameter R(T) is small. By utilizing a waveguide layer 30 with a negative thermo-optical coefficient, embodiments of the present invention are able to provide a thermal response parameter R(T) which is preferably less than 8×10⁻⁶/° C., more preferably less than 6×10⁻⁶/° C., even more preferably less than approximately 4×10⁻⁶/° C., and most preferably equal to approximately zero.

By virtue of having little or no thermal response, athermal waveguide devices 10 compatible with embodiments of the present invention can avoid cumbersome and expensive temperature control subsystems required by prior art devices. For example, integrated optical devices installed in inaccessible areas, such as splitters or power devices in underground cabling systems, require temperature compensation subsystems with corresponding power and control circuitry. By reducing or eliminating the need for such subsystems, athermal devices provide an attractive alternative for these environments.

In addition, athermal waveguide devices 10 compatible with embodiments of the present invention can provide smaller devices which are more easily integrated into smaller optical systems. Such athermal waveguide devices 10 can also be made more cheaply by virtue of utilizing inexpensive materials for the substrate 20 and by simplifying manufacturing by utilizing materials requiring fewer fabrication steps.

Alternatively in other embodiments, the temperature-dependent wavelength shift dλ/dT equals a predetermined value by tailoring the values of the thermo-optical coefficient dn_{g}/dT, refractive index ng of the waveguide layer 30, and the thermal coefficient of expansion α_{sub} of the substrate 20. In such embodiments, the temperature-dependent wavelength shift dλ/dT can be preselected to track the thermal response of other components of the optical system. For example, a temperature-dependent wavelength shift of a laser source can be tracked by the tailored temperature-dependent wavelength shift dλ/dT of the waveguide device 10.

Polymeric athermal waveguide devices 10 compatible with embodiments of the present invention also provide additional benefits not found in silicon/polymer devices. Unlike silicon/polymer devices, devices 10 made entirely of polymeric materials do not suffer from the potential delamination which can occur during polishing. Because the thermal expansion coefficients are similar for all portions of the polymeric athermal waveguide device 10, the thermal stresses generated by temperature changes can be less than in silicon/polymer devices, thereby potentially reducing polarization dependent losses (PDL). Polymeric athermal waveguide devices 10 also have correspondingly less equipment capital costs due to the reduced complexity of the fabrication process and have less environmental impact due to the elimination of toxic gases (e.g., phosphines or arsines) used for fabricating silicon/polymer devices.

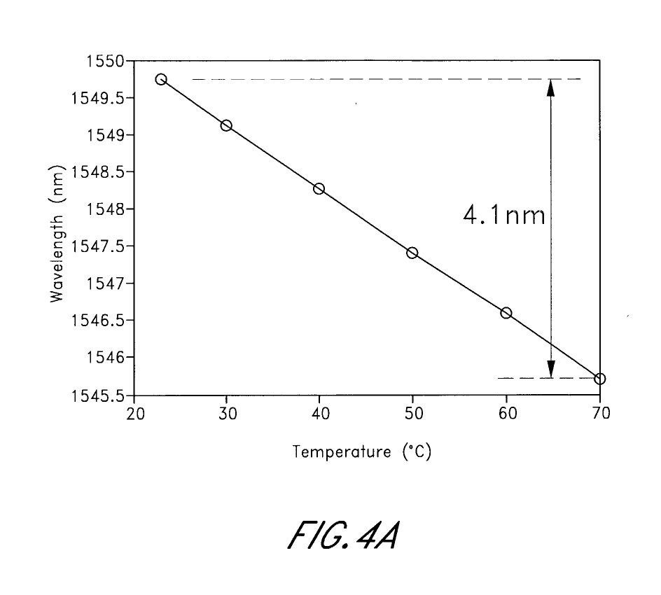

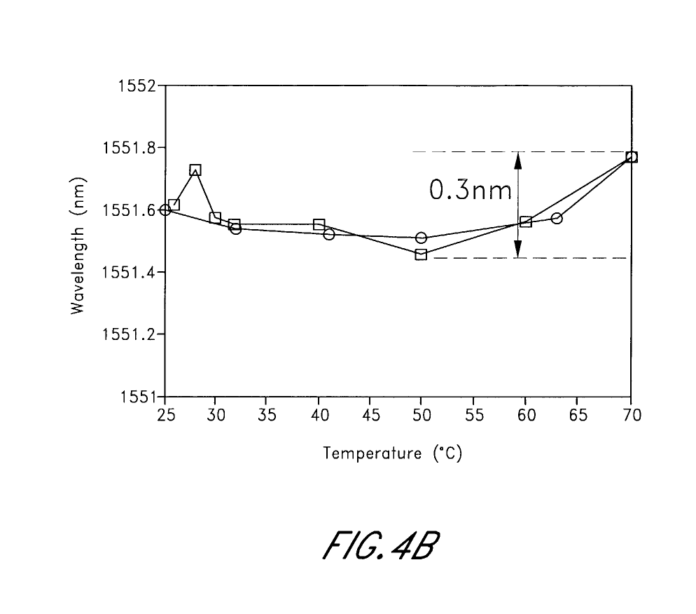

FIG. 4 is a graphical comparison of the measured temperature-dependent wavelength shift dλ/dT for a polymeric WDM on a silicon substrate (FIG. 4A) and a polymeric WDM on a polymeric substrate 20 comprising CTFE polymer (FIG. 4B). The waveguide layer 30 of both WDMs is polymeric and comprises styrenic acrylate terpolymer with epoxy functionality for crosslinking by ultraviolet radiation.

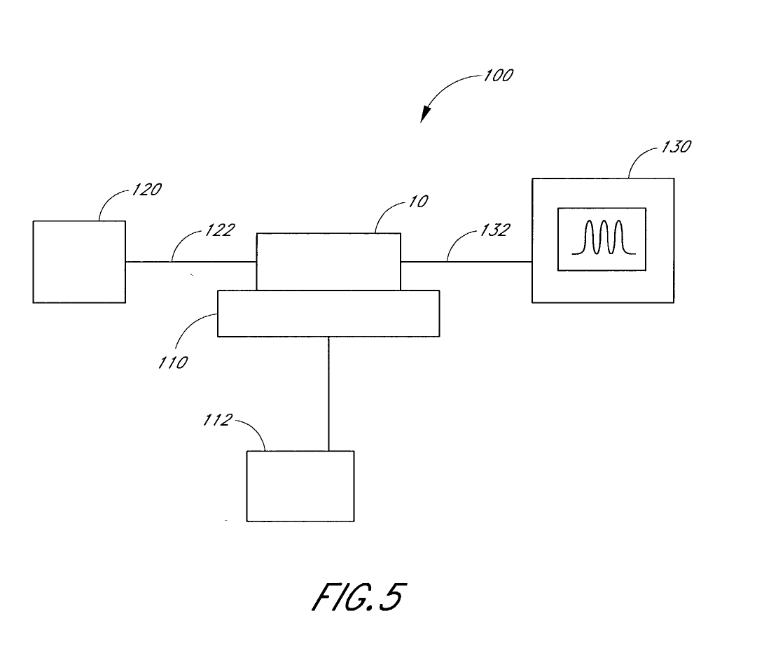

FIG. 5 schematically illustrates a data acquisition system 100 used to compile the data illustrated in FIGS. 4A and 4B. The waveguide device 10 was placed on a heater 110 and coupled to a broadband laser 120 which provided input signals to the device 10 via an input optical fiber 122. Output signals from selected channels of the device 10 were transmitted to an optical spectrum analyzer (OSA) 130 via one or more output optical fibers 132. The temperature of the waveguide device 10 was controlled by a temperature controller 112 coupled to the heater 110. In this way, wavelength shifts of the output signals were observed as a function of temperature.

As illustrated in FIG. 4A, the wavelength shift dλ/dT of the central wavelength of the polymeric WDM on the silicon substrate exhibits a generally linear decrease of approximately 4.1 nm (±2.05 nm) over the temperature range of 20° C. to 70° C. In contrast, as illustrated in FIG. 4B, the wavelength shift dλ/dT of the central wavelength of the polymeric WDM device 10 on the CTFE polymeric substrate 20 exhibits a total central wavelength shift of approximately 0.3 nm (±0.15 nm) over the temperature range of 25° C. to 70° C. Other embodiments compatible with embodiments of the present invention can provide WDMs with central wavelengths which exhibit a total central wavelength shift of approximately 0.5 nm (±0.25 nm) over the temperature range of approximately 25° C. to approximately 70° C.

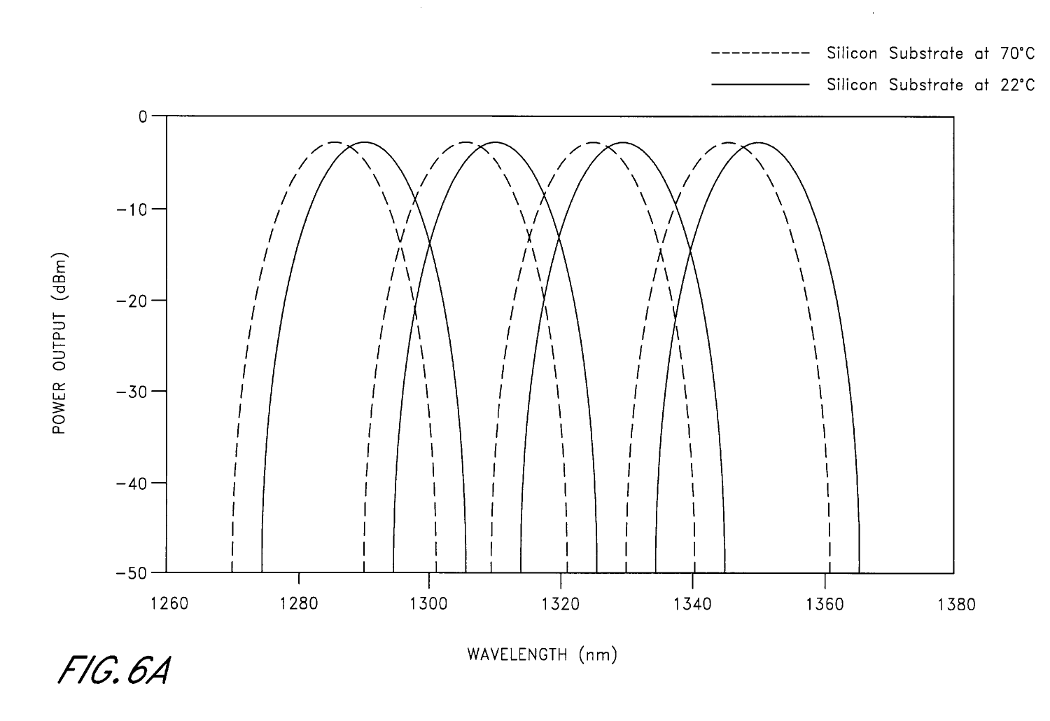

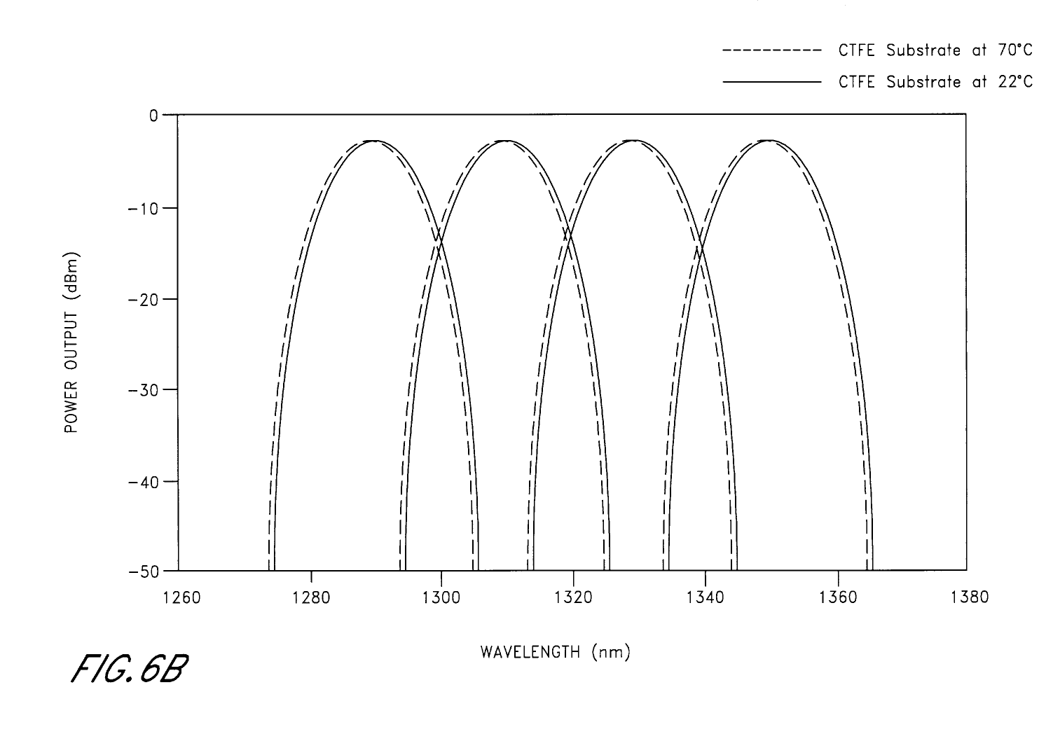

FIGS. 6A and 6B are a graphical comparison of simulated output power for four output channels for a polymeric CWDM on the silicon substrate (FIG. 6A) and a polymeric CWDM device 10 on a polymeric substrate 20 comprising CTFE polymer (FIG. 6B). The solid curves in these figures correspond to the output power at approximately 20° C. and the dashed curves correspond to the output power at approximately 70° C. As illustrated in FIG. 6A, the output power of the CWDM on the silicon substrate at 70° C. exhibits significant thermally-induced shifts to smaller wavelengths as compared to the output power at 20° C.

In contrast, as illustrated in FIG. 6B, the output power of the CWDM device 10 on the polymeric substrate 20 comprising CTFE polymer at 70° C. exhibits only a small thermally-induced wavelength shift as compared to the output power at 20° C. The thermally-induced wavelength shift for the polymeric CWDM device 10 on the polymeric substrate 20 is well within the tolerance of 0.043 nm/° C. over a temperature range of approximately 25° C. to approximately 70° C. for CWDM devices corresponding to channel spacings of approximately 20 nm. Polymeric substrates 20 compatible with embodiments of the present invention are also capable of providing small thermally-induced wavelength shifts which conform to thermal shifts of less than 0.004 nm/° C. over a temperature range of approximately 25° C. to approximately 70° C. for DWDMs based on the 0.8-mn grid (100 GHz) spacings between channels defined by the International Telecommunications Union (ITU) from a reference frequency of 193.1 THz (1552.52 nm).

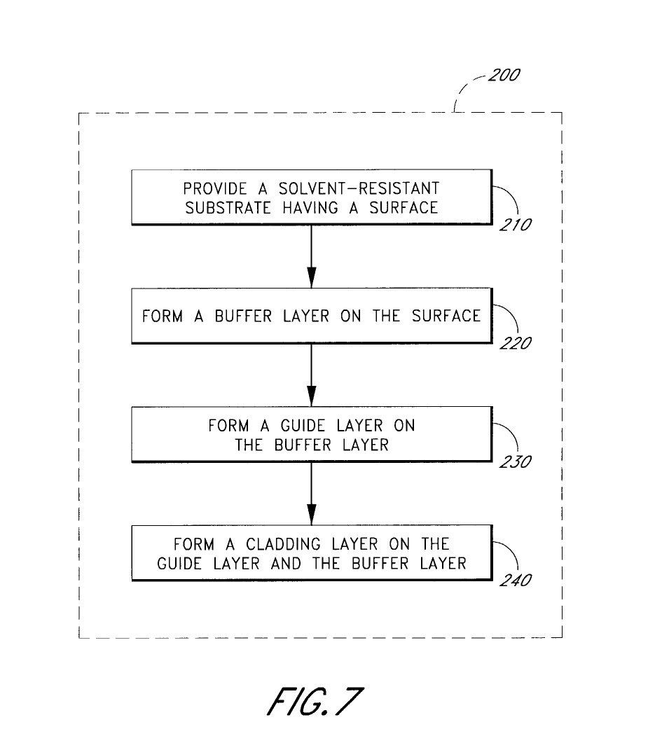

FIG. 7 is a flow diagram of an exemplary method 200 for fabricating a waveguide device 10 using wet etch processing, the waveguide device 10 having a tailored thermal response in accordance with embodiments of the present invention. In the operational block 210, a solvent-resistant substrate 20 is provided. The substrate 20 has a surface 22 and the substrate 20 has a thermal coefficient of expansion, as described above. In certain embodiments, the substrate 20 comprises CTFE polymer, which can be mechanically diced from sheets (e.g., 1-2 mm in thickness) to the desired dimensions.

In the operational block 220, a buffer layer 32 is formed on the surface 22 of the substrate 20. In certain embodiments, the buffer layer 32 comprises a copolymer with styrenic and epoxy acrylate functionality (for thermal crosslinking) comprising glycidyl methacrylate, tert-butyl methacrylate, and 2,2′ azobisisobutyronitrile. Solvents compatible with this material include, but are not limited to, ketones, acetates, and aromatic hydrocarbons. The buffer layer 32 of certain such embodiments is spin-coated onto the surface 22 which is spinning at approximately 200 rpm, and is baked at approximately 180° C. for approximately two hours in an oven. The resultant buffer layer 32 has a thickness of approximately 13 microns and has a temperature-dependent refractive index of approximately 1.474 at room temperature.

In the operational block 230, a guide layer 34 is formed on the buffer layer 32. In certain embodiments, the guide layer 34 comprises a styrenic acrylate terpolymer with epoxy functionality for crosslinking by ultraviolet radiation, which has a temperature-dependent refractive index of approximately 1.485 at room temperature, and a thermo-optical coefficient of approximately −8×10⁻⁵/° C. The guide layer 34 of certain such embodiments is spin-coated onto the buffer layer 32 which is spinning at approximately 300 rpm. A hot plate is then used to expose the guide layer 34 to a pre-exposure bake at approximately 100° C. for approximately 35 seconds. A portion of the guide layer 34 is then exposed to light with a wavelength of approximately 365 nm through a mask, with an exposure of approximately 21 mW/cm² for approximately 80 seconds.

After a post-exposure bake at approximately 130° C. for approximately 90 seconds using a hot plate, the guide layer 34 is patterned by wet etching at approximately room temperature by exposing the guide layer 34 to acetone for approximately 60 seconds. The wet etch removes material from the guide layer 34 which was not exposed to the light, while leaving the buffer layer 32 and the substrate 20 unaffected. Other solvents compatible with embodiments of the present invention include, but are not limited to, inorganic corrosive liquids such as oxidizing acids, organic solvents excluding aromatic materials such as toluenes, mild alcohols, mild acids, mild alkalis, esters, ethers, and ketones. The guide layer 34 is then exposed to a final bake at approximately 170° C. for approximately three minutes, at approximately 130° C. for approximately 30 minutes while under a nitrogen atmosphere, and at approximately 130° C. for approximately 30 minutes while under vacuum. In certain embodiments, the resulting guide layer 34 comprises waveguides which are approximately 7 microns wide by 7 microns in thickness.

In the operational block 240, a cladding layer 36 is formed on the patterned guide layer 34 and the buffer layer 32. In certain embodiments, the cladding layer 36 comprises a copolymer with styrenic and epoxy acrylate functionality (for thermal crosslinking) comprising glycidyl methacrylate, tert-butyl methacrylate, and 2,2′ azobisisobutyronitrile. Solvents compatible with this material include, but are not limited to, ketones, acetates, and aromatic hydrocarbons. The cladding layer 36 of certain such embodiments is spin-coated onto the guide layer 34 and the buffer layer 32 which are spinning at approximately 180 rpm, and is baked at approximately 130° C. for approximately 1.5 hours in an oven. The resultant cladding layer 36 has a thickness of approximately 13 microns and has a temperature-dependent refractive index of approximately 1.474 at room temperature. In certain embodiments, both the cladding layer 36 and the buffer layer 32 comprise the same material.

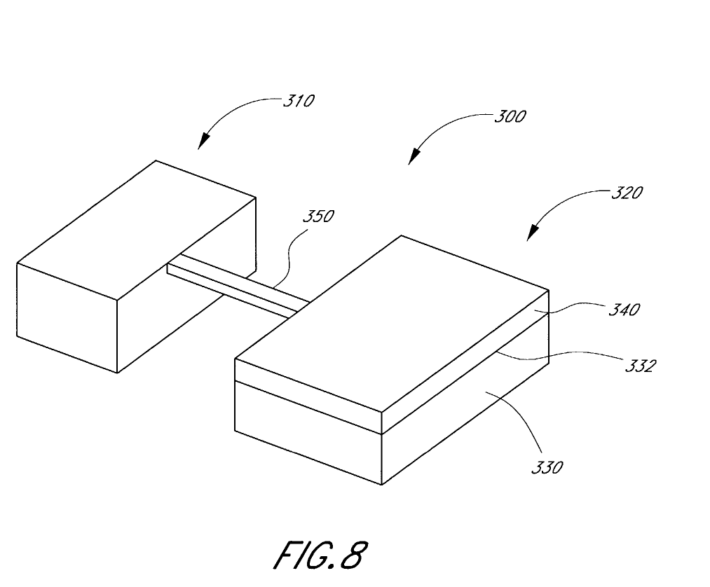

FIG. 8 schematically illustrates a temperature-compensated optical system 300 in accordance with embodiments of the present invention. The optical system 300 comprises a first optical device 310 having a first thermal response. The optical system 300 further comprises a second optical device 320 optically coupled to the first optical device 310. The second optical device 320 has a second thermal response which compensates for the first thermal response. The second optical device 320 comprises a solvent-resistant substrate 330 comprising a surface 332, the substrate 330 having a thermal coefficient of expansion α_{sub}. The second optical device 320 further comprises a waveguide layer 340 formed on the surface 332 of the substrate 330. The waveguide layer 340 has a temperature-dependent refractive index n_{g} characterized by a negative thermo-optical coefficient dn_{g}/dT. The second thermal response comprises a temperature-dependent wavelength shift dλ/dT proportional to a thermal response parameter R(T) equal to a sum of the thermo-optical coefficient dn_{g}/dT and the product of the refractive index n_{g} and the thermal coefficient of expansion α_{sub}.

In certain such embodiments, the first optical device 310 comprises a laser (e.g., a distributed feedback laser) having a temperature-dependent wavelength shift. As schematically illustrated in FIG. 8, the second optical device 320 is optically coupled to the first optical device 310 by a waveguide 350 in certain embodiments.

The temperature-dependent wavelength shift dλ/dT of the second optical device 320 can be tailored to compensate for the temperature-dependent wavelength shift of the first optical device 310, resulting in an optical system 300 that is less sensitive to fluctuations in temperature. In certain such embodiments, the temperature-dependent wavelength shift of the second optical device 320 is tailored to track the temperature-dependent wavelength shift of the first optical device 310 by judiciously selecting the values of the thermo-optical coefficient dn_{g}/dT, refractive index n_{g} of the waveguide layer 340, and the thermal coefficient of expansion α_{sub} of the substrate 330.

Although described above in connection with particular embodiments of the present invention, it should be understood the descriptions of the embodiments are illustrative of the invention and are not intended to be limiting. Various modifications and applications may occur to those skilled in the art without departing from the true spirit and scope of the invention as defined in the appended claims.

What is claimed is:

1. A waveguide device having a tailored thermal response, the waveguide device comprising:
a solvent-resistant substrate comprising a surface, the substrate having a thermal coefficient of expansion and comprising chlorotrifluoroethylene (CTFE) polymer; and
a waveguide layer formed on the surface of the substrate, the waveguide layer having a temperature-dependent refractive index characterized by a negative thermo-optical coefficient, whereby the thermal response of the waveguide device comprises a temperature-dependent wavelength shift proportional to a thermal response parameter equal to a sum of the thermo-optical coefficient and the product of the refractive index and the thermal coefficient of expansion.

2. The polymeric waveguide device of claim 1, wherein the absolute value of the thermal response parameter is less than approximately 8×10⁻⁶ per degree Celsius.

3. The polymeric waveguide device of claim 1, wherein the absolute value of the thermal response parameter is less than approximately 6×10⁻⁶ per degree Celsius.

4. The polymeric waveguide device of claim 1, wherein the absolute value of the thermal response parameter is less than approximately 4×10⁻⁶ per degree Celsius.

5. The polymeric waveguide device of claim 1, wherein the thermal response parameter is equal to approximately zero.

6. The polymeric waveguide device of claim 1, wherein the thermal response parameter equals a predetermined value.

7. The waveguide device of claim 1, wherein the device comprises a wavelength-division multiplexer/demultiplexer having a total central wavelength shift less than or equal to approximately 0.5 nm over a temperature range of 25 degrees Celsius to 70 degrees Celsius.

8. The waveguide device of claim 1, wherein the device comprises a wavelength-division multiplexer/demultiplexer having a total central wavelength shift less than or equal to approximately 0.3 nm over a temperature range of 25 degrees Celsius to 70 degrees Celsius.

9. The waveguide device of claim 1, wherein the device comprises a wavelength-division multiplexer/demultiplexer having a central wavelength which shifts less than approximately 0.043 nm/° C. over a temperature range of approximately 25° C. to approximately 70° C.

10. The waveguide device of claim 1, wherein the device comprises a wavelength-division multiplexer/demultiplexer having a central wavelength which shifts less than approximately 0.004 nm per degree Celsius over a temperature range of approximately 25° C. to approximately 70° C.

11. A waveguide device having a tailored thermal response, the waveguide device comprising:
a solvent-resistant substrate comprising a surface, the substrate having a thermal coefficient of expansion and comprising polyetherimide; and
a waveguide layer formed on the surface of the substrate, the waveguide layer having a temperature-dependent refractive index characterized by a negative thermo-optical coefficient, whereby the thermal response of the waveguide device comprises a temperature-dependent wavelength shift proportional to a thermal response parameter equal to a sum of the thermo-optical coefficient and the product of the refractive index and the thermal coefficient of expansion.

12. A waveguide device having a tailored thermal response, the waveguide device comprising:
a solvent-resistant substrate comprising a surface, the substrate having a thermal coefficient of expansion and comprising a material selected from the group consisting of polyethylfluoroethylene, glass-filled poly(imide), glass-filled black polycarbonate, and fluoro-ethylene-propylene polymer; and
a waveguide layer formed on the surface of the substrate, the waveguide layer having a temperature-dependent refractive index characterized by a negative thermo-optical coefficient, whereby the thermal response of the waveguide device comprises a temperature-dependent wavelength shift proportional to a thermal response parameter equal to a sum of the thermo-optical coefficient and the product of the refractive index and the thermal coefficient of expansion.

13. A waveguide device having a tailored thermal response, the waveguide device comprising:
a solvent-resistant substrate comprising a surface, the substrate having a thermal coefficient of expansion and comprising a material selected from the group consisting of chlorotrifluoroethylene (CTFE) polymer, polyetherimide, polyethylfluoroethylene, glass-filled poly(imide), glass-filled black polycarbonate, and fluoro-ethylene-propylene polymer; and
a waveguide layer formed on the surface of the substrate, the waveguide layer having a temperature-dependent refractive index characterized by a negative thermo-optical coefficient, whereby the thermal response of the waveguide device comprises a temperature-dependent wavelength shift proportional to a thermal response parameter equal to a sum of the thermo-optical coefficient and the product of the refractive index and the thermal coefficient of expansion.

14. A method for fabricating a waveguide device using wet etch processing, the waveguide device having a tailored thermal response, the method comprising:
providing a solvent-resistant substrate having a surface, the substrate having a thermal coefficient of expansion and comprising chlorotrifluoroethylene (CTFE) polymer;
forming a buffer layer on the surface of the substrate;
forming a guide layer on the buffer layer, wherein forming the guide layer comprises patterning the guide layer by exposing the guide layer, buffer layer, and substrate to a solvent, the guide layer having a temperature-dependent refractive index characterized by a negative thermo-optical coefficient;
forming a cladding layer on the patterned guide layer and the buffer layer; and
tailoring the thermal response of the waveguide device, the thermal response dependent on the thermal coefficient of expansion, on the temperature-dependent refractive index, and on the thermo-optical coefficient.

15. The method of claim 14, wherein the solvent comprises acetone.

16. The method of claim 14, wherein the solvent comprises inorganic corrosive liquid, organic solvents, mild alcohols, mild acids, mild alkalis, esters, ethers, or ketones.

17. A method for fabricating a waveguide device using wet etch processing, the waveguide device having a tailored thermal response, the method comprising:
providing a solvent-resistant substrate having a surface, the substrate having a thermal coefficient of expansion and comprising polyetherimide;
forming a buffer layer on the surface of the substrate;
forming a guide layer on the buffer layer, wherein forming the guide layer comprises patterning the guide layer by exposing the guide layer, buffer layer, and substrate to a solvent, the guide layer having a temperature-dependent refractive index characterized by a negative thermo-optical coefficient;
forming a cladding layer on the patterned guide layer and the buffer layer; and
tailoring the thermal response of the waveguide device, the thermal response dependent on the thermal coefficient of expansion, on the temperature-dependent refractive index, and on the thermo-optical coefficient.

18. A method for fabricating a waveguide device using wet etch processing, the waveguide device having a tailored thermal response, the method comprising:
providing a solvent-resistant substrate having a surface, the substrate having a thermal coefficient of expansion and comprising a material selected from the group consisting of polyethylfluoroethylene, glass-filled poly(imide), glass-filled black polycarbonate, and fluoro-ethylene-propylene polymer;
forming a buffer layer on the surface of the substrate;
forming a guide layer on the buffer layer, wherein forming the guide layer comprises patterning the guide layer by exposing the guide layer, buffer layer, and substrate to a solvent, the guide layer having a temperature-dependent refractive index characterized by a negative thermo-optical coefficient;
forming a cladding layer on the patterned guide layer and the buffer layer; and
tailoring the thermal response of the waveguide device, the thermal response dependent on the thermal coefficient of expansion, on the temperature-dependent refractive index, and on the thermo-optical coefficient.

19. A method for fabricating a waveguide device using wet etch processing, the waveguide device having a tailored thermal response, the method comprising:
providing a solvent-resistant substrate having a surface, the substrate having a thermal coefficient of expansion and comprising a material selected from the group consisting of polycarbonates, polycyanurates, polyolefins, condensation polymers, polyacrylates, polysiloxanes, polyimides, ceramics, and doped glasses;
forming a buffer layer on the surface of the substrate;
forming a guide layer on the buffer layer, wherein forming the guide layer comprises patterning the guide layer by exposing the guide layer, buffer layer, and substrate to a solvent, the guide layer having a temperature-dependent refractive index characterized by a negative thermo-optical coefficient;
forming a cladding layer on the patterned guide layer and the buffer layer; and
tailoring the thermal response of the waveguide device, the thermal response dependent on the thermal coefficient of expansion, on the temperature-dependent refractive index, and on the thermo-optical coefficient.

20. A temperature-compensated optical system comprising:
a first optical device having a first thermal response; and
a second optical device optically coupled to the first optical device, the second optical device having a second thermal response which compensates for the first thermal response, the second optical device comprising:
a solvent-resistant substrate comprising a surface, the substrate having a thermal coefficient of expansion; and
a waveguide layer formed on the surface of the substrate, the waveguide layer having a temperature-dependent refractive index characterized by a negative thermo-optical coefficient, whereby the second thermal response comprises a temperature-dependent wavelength shift proportional to a thermal response parameter equal to a sum of the thermo-optical coefficient and the product of the refractive index and the thermal coefficient of expansion.

21. The optical system of claim 20, wherein the first optical device is a laser and the first thermal response is a temperature-induced wavelength shift of the laser.
